(19) United States
(12) Patent Application Publication
(10) Pub. No.: US 2022/0082145 A1
(43) Pub. Date: Mar. 17, 2022

(54) WET FRICTION MEMBER AND WET FRICTION PLATE USING WET FRICTION MEMBER

(71) Applicant: NSK-WARNER K.K., Tokyo (JP)

(72) Inventors: Hideaki TAKABAYASHI, Fukuroi-shi (JP); Shun KITAHARA, Fukuroi-shi (JP); Misako SUZUKI, Fukuroi-shi (JP); Ryo OKADA, Fukuroi-shi (JP)

(21) Appl. No.: 17/463,443

(22) Filed: Aug. 31, 2021

(30) Foreign Application Priority Data
Sep. 14, 2020 (JP) 2020-153773

(51) Int. Cl. F16D 69/02; F16D 25/0635

(52) U.S. Cl. CPC F16D 69/023; F16D 2200/0052; F16D 2200/0065; F16D 25/0635

(57) ABSTRACT

Disclosed is a wet friction member for use in a wet clutch or a wet brake that has improved heat conductivity and tends not to damage a mating plate which is engaged with it to improve the endurance of the mating plate. The wet friction member 1 includes base paper formed from a fiber base material and a filler and a binder for curing the base paper. The base paper contains a carbon-based material and does not contain diatomaceous earth.

The disclosure of the following priority application is herein incorporated by reference:

Japanese Patent Application No. 2020-153773 filed on Sep. 14, 2020.

### TECHNICAL FIELD

The present invention relates to a wet friction member for use in a wet clutch or a wet brake used in an automatic transmission of a vehicle, such as an automobile. The present invention also relates to a wet friction plate using the wet friction member.

### BACKGROUND ART

Electrification of vehicle power sources has been proceeding nowadays. In cases where electric motors are used as drive sources of vehicles, the automatic transmission used therewith may sometimes operate at higher rotation speeds than in cases where conventional drive sources are used. In such high rotation speed conditions, there is a possibility that too much heat may accumulate in a wet friction member used in a wet clutch or a wet brake and that a mating plate which is engaged with the wet friction member may be affected (e.g. thermally deformed) by the heat accumulated in the wet friction member. In consequence, in high rotation speed conditions, heat load may deteriorate the endurance of the mating plate to be engaged with the wet friction member.

Patent Literature 1 in the citation list below teaches to improve the heat conductivity of a wet friction member by mixing metal powder in the base material of the wet friction member, thereby preventing the wet friction member from seizure onto a mating member that is engaged with it at high temperature.

### CITATION LIST

### Patent Literature

Patent Literature 1: Japanese Patent Application Laid-Open No. H6-147242

### SUMMARY OF INVENTION

### Technical Problem

Wet friction members using a base material that contains metal powder mixed in it as taught by Patent Literature 1 tend to damage mating members which are engaged with them at high rotation speed conditions. This can lead to deterioration in the endurance of the mating members which are engaged with the wet friction members.

The present invention has been made in the above circumstances, and its object is to provide a wet friction member for use in a wet clutch or a wet brake that has improved heat conductivity and tends not to damage a mating plate which is engaged with it to improve the endurance of the mating plate.

### Solution to Problem

To achieve the above object, according to the present invention, there is provided a wet friction member comprising:

base paper formed from a fiber base material and a filler;

and

a binder for curing the base paper,

wherein the base paper contains a carbon-based material and does not contain diatomaceous earth.

### Advantageous Effects of the Invention

The present invention can provide a wet friction member for use in a wet clutch or a wet brake that has improved heat conductivity. Moreover, since the wet friction member does not contain metal powder added to its base material, the damage of a mating plate engaged with it is reduced, so that the endurance of the mating plate can be improved.

### BRIEF DESCRIPTION OF DRAWINGS

FIG. 1A is a schematic front view of a wet friction plate using a wet friction member according to an embodiment of the present invention.

FIG. 1B is an enlarged cross sectional view taken on line b-b in FIG. 1A, showing a cross section of the wet friction member.

FIG. 2 is a graph showing the result of a test of determining heat conductivity.

FIG. 3 is a graph showing the result of evaluation of sliding surface temperature.

FIGS. 4A and 4B schematically show seizure of mating plates which were engaged with a wet friction member, where FIG. 4A shows a part of the surface of a mating plate engaged with a wet friction member as a comparative example, and FIG. 4B shows a part of the surface of a mating plate engaged with a wet friction member according to an example of the embodiment.

### EMBODIMENT FOR CARRYING OUT THE INVENTION

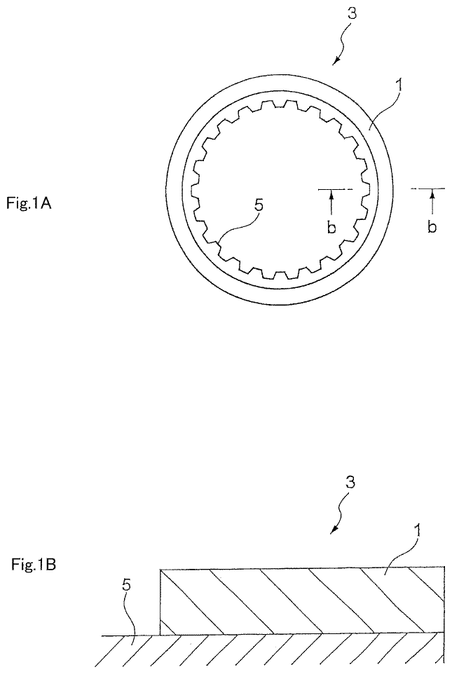

A wet friction member and a wet friction plate according to an embodiment of the present invention will be described. FIG. 1A is a schematic front view of a wet friction plate using a wet friction member according to the embodiment. FIG. 1B is an enlarged cross sectional view taken on line b-b in FIG. 1A, showing a cross section of the wet friction member.

The wet friction member 1 according to the embodiment is one for use in a wet clutch (not shown) or a wet brake (not shown) used in an automatic transmission of a vehicle, such as an automobile. The wet friction member 1 and the wet friction plate 3 according to the embodiment are produced in the following way. The wet friction member 1 is produced by making base paper by a paper-making process from a fiber base material to which a filler and a friction-adjusting agent are added, impregnating the base paper with a binder, such as a thermosetting resin, and curing it. The wet friction plate 3 is produced by punching the wet friction member 1 produced in the above way into a designed shape and adhering it to an annular core 5.

As the fiber base material, use may be made of one or more of fibers containing an inorganic compound having high heat conductivity, such as a silicon-based or alumina-based inorganic compound, and organic fibers, such as aramid fibers and carbon fibers.

As the filler and the friction-adjusting agent, use may be made of one or more of an inorganic compound, such as carbon or calcium carbonate, and an organic compound, such as a synthetic rubber.

The wet friction member 1 according to the embodiment uses aramid fibers and carbon fibers as the carbon based material to constitute the fiber base material, and uses graphite as the filler added to the fiber base material. Carbon fibers and graphite are carbon-based materials. While diatomaceous earth is widely used as a filler added to the fiber base material, the wet friction member 1 of this embodiment does not use diatomaceous earth as the filler. In other words, the base paper does not contain diatomaceous earth. Carbon fibers and graphite are materials having higher heat conductivity than diatomaceous earth. The percentage content of carbon-based materials (i.e. carbon fibers and graphite) in the wet friction member 1 according to the embodiment is larger than that in conventional wet friction members.

The wet friction member 1 according to the embodiment is produced by making base paper by a conventional paper-making process from a fiber base material made of aramid fibers and carbon fibers to which graphite is added as a filler, impregnating the base paper with a binder, such as a thermosetting resin, and curing it. The wet friction plate 3 of this embodiment is produced by punching the wet friction member 1 produced in this way into a designed shape and integrating it with a core 5 as a substrate applied with adhesive by heat pressing.

As described above, the wet friction member 1 according to the embodiment does not use diatomaceous earth as a filler added to the fiber base material. Diatomaceous earth generally has low heat conductivity, as will be understood from its known use in heat insulators. Consequently, the heat conductivity of the wet friction member 1 of this embodiment can be made higher than wet friction members using base paper containing diatomaceous earth. Moreover, since the percentage content of graphite added to the fiber base material as a filler is larger than that in conventional wet friction members, the heat conductivity of the wet friction member 1 can be further increased. Thus, the wet friction member 1 according to the embodiment has enhanced heat conductivity. This can prevent excessive accumulation of heat in the wet friction member 1. In consequence, seizure or heat deformation of a mating plate which is engaged with the wet friction member 1 can be prevented from being caused by heat accumulation in the wet friction member 1. The wet friction member 1 according to the embodiment does not contain metal powder. This leads to reduced damage given to a mating plate to be engaged with the wet friction member 1 even in high rotation speed conditions. Thus, the wet friction member 1 of this embodiment can enhance the endurance of the mating plate which is engaged with it.

When the wet friction member 1 according to the embodiment is used in a wet clutch or brake, its improved heat conductivity allows a reduction in its area. Specifically, for example, if the outer diameter of the wet friction member 1 according to the embodiment is the same as that of a conventional wet friction member, the inner diameter of the wet friction member 1 according to the embodiment can be made larger than that of the conventional wet friction member. If the inner diameter of the wet friction member 1 according to the embodiment is the same as that of a conventional wet friction member, the outer diameter of the wet friction member 1 according to the embodiment can be made smaller than that of the conventional wet friction member. This allows size-reduction of the wet clutch or brake. Not only the area of the wet friction member 1 but also the number of wet friction plates 3 can be reduced.

### EXAMPLE

In the following, an example of the wet friction member according to the embodiment will be described. Moreover, evaluation of the example in comparison with a comparative example will also be described. While the evaluation described in the following was conducted with wet clutches using wet friction members according to the embodiment, the result of evaluation also applies to wet brakes using wet friction members according to the embodiment.

We made an example of the wet friction member according to the embodiment and a wet friction member having a conventional composition as a comparative example by the above-described method. Table 1 below shows the proportions of the components of the example of the wet friction member according to the embodiment and the comparative example. The proportions in table 1 are in weight percent. As shown in table 1, the example of the wet friction member according to the embodiment does not contain diatomaceous earth as a filler. In contrast, the comparative example of the wet friction member contains diatomaceous earth, as is generally the case with conventional wet friction members. The percentage content of carbon fibers and the percentage content of the graphite (namely, the percentage content of the carbon-based materials) in the example of the wet friction member according to the embodiment are twice as much as those in the comparative example.

TABLE 1

| | comparative example | example |
|---|---|---|
| aramid fibers (%) | 35 | 30 |
| binder (resin) (%) | 30 | 30 |
| diatomaceous | 15 | — |
| earth (%) | | |
| carbon fibers (%) | 10 | 20 |
| graphite (%) | 10 | 20 |

We conducted a test to determine the heat conductivity of the example of the wet friction member according to the embodiment and that of the comparative example. Specifically, we produced a wet clutch plate by adhering the wet friction members according to the embodiment to the side surfaces of a core, gave a predetermined heat to the surface of the friction members of the wet clutch plate, measured changes in the temperature of the core with time, and determined the heat conductivity of the wet friction member from changes in the temperature of the core with time. We also determined the heat conductivity of the comparative example of the wet friction member in the same way.

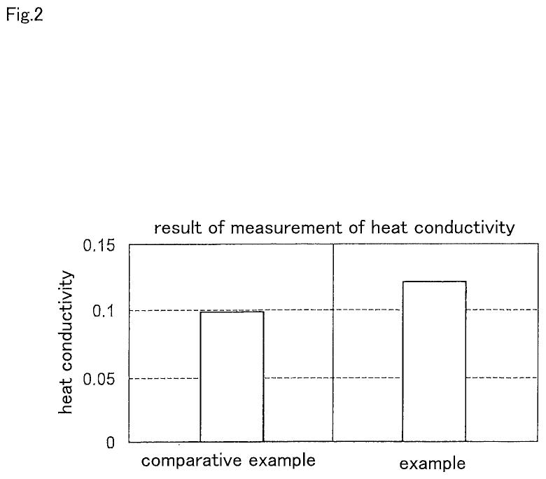

FIG. 2 is a graph showing the result of the test of determining heat conductivity. The unit of heat conductivity in FIG. 2 is W/(m·K).

As shown in FIG. 2, the heat conductivity of the comparative example was 0.095 W/(m·K), and the heat conductivity of the example according to the embodiment was 0.125 W/(m·K). The heat conductivity of the example according to the embodiment was 32% higher than that of the comparative example.

We also conducted measurement and evaluation of the sliding surface temperature with respect to the example and the comparative example of the wet friction member. The sliding surface temperature mentioned here refers to the temperature of mating plates that are engaged with the wet clutch plates having the adhered wet friction members. The sliding surface temperature was measured while engagement and disengagement of the wet clutch plates and the mating plates with and from each other were repeated certain numbers of cycles. In this evaluation, thermo-couples were attached to the mating plates along the thickness direction thereof. The wet clutch plates having the adhered wet friction members according to the embodiment and the mating plates are arranged alternately and set in a test machine. The measurement and evaluation were conducted up to 250 cycles of engagement and disengagement of the wet clutch plates and the mating plates under the evaluation condition specified in Table 2 below. The measurement and evaluation were also conducted with respect to the wet friction plates according to the comparative example.

TABLE 2
Evaluation of Sliding Surface Temperature

| | condition |
|---|---|
| Rotation speed (rpm) | 7600 |
| Lubrication (L/min) | 1.0 (center axis) |
| oil temperature (° C.) | 100 |
| moment of inertia (kg · m²) | 0.123 |
| number of clutch plates | 3 |

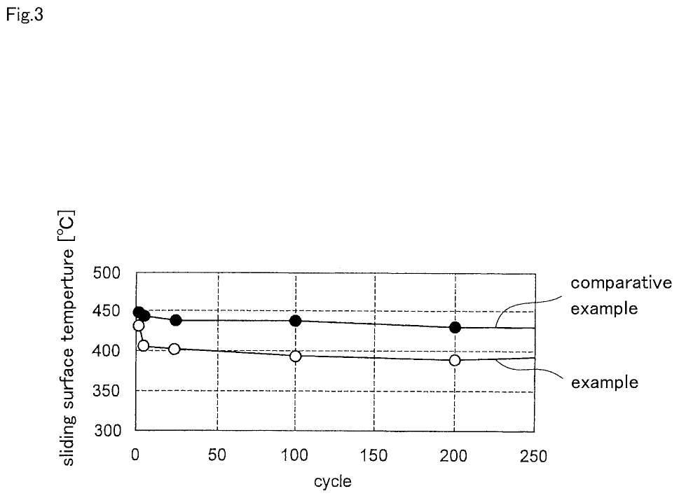

FIG. 3 is a graph showing the result of evaluation of the sliding surface temperature measurement.

The sliding surface temperature became stable after 200 cycles of engagement and disengagement of the wet clutch plates and the mating plates. Therefore, the evaluation was conducted by comparing the sliding surface temperatures at the 200th cycle. The sliding surface temperature of the comparative example at that time was 430° C., and the sliding surface temperature of the example according to the embodiment was 380° C. The sliding surface temperature of the example according to the embodiment was 12% lower than that of the comparative example. This indicates that the example according to the embodiment is improved in heat conductivity. The sliding surface temperatures measured as above are rises in the temperature from the oil temperature that was set to 100° C. as the reference temperature.

We also conducted evaluation of high energy heat spots with respect to the example of the wet friction members according to the embodiment and the comparative example.

In the evaluation of high energy heat spots, engagement and disengagement of the wet clutch plates having the adhered wet friction members according to the embodiment and the mating plates were repeated certain numbers of cycles under the evaluation condition specified in Table 3 below. Then, after cooling the mating plates, seizure of the mating plates or the presence of heat spots was checked by visual observation. The evaluation was also conducted with the comparative example of the wet friction member.

TABLE 3
Evaluation of High Energy Heat Spots

| | condition |
|---|---|
| Rotation speed (rpm) | 7300 |
| Lubrication (L/min) | 1.0 (center axis) |
| oil temperature (° C.) | 100 |
| moment of inertia (kg · m²) | 0.123 |
| number of clutch plates | 3 |

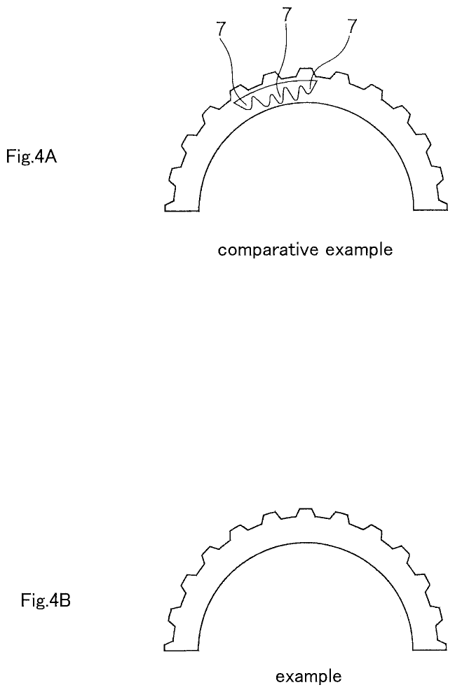

FIGS. 4A and 4B schematically show seizure of mating plates that are engaged with the wet clutch plates having the adhered wet friction members, where FIG. 4A shows a part of the surface of a mating plate engaged with the comparative example of the wet friction member, and FIG. 4B shows a part of the surface of a mating plate engaged with the wet friction member according to the example of the embodiment.

As shown in FIG. 4A, a plurality of heat spots 7 were seen on the surface of the mating plate engaged with the comparative example of the wet friction member. In contrast, as shown in FIG. 4B, no heat spots were seen on the surface of the mating plate engaged with the wet friction member according to the example of the embodiment. This indicates that the wet friction member according to the example of the embodiment is advantageous in that heat accumulation resulting from repeated engagement and disengagement with and from the mating plate is lower, and seizure on the mating plate and heat deformation of the mating plate due to accumulated heat are prevented or reduced.

As above, the wet friction member according to the embodiment can be used in a wet clutch or a wet brake. Since the wet friction member according to the embodiment has improved heat conductivity. Since the wet friction member according to the embodiment does not contain metal powder added to its base material, the damage of the mating plate caused by it is reduced, so that the endurance of the mating plate can be improved.

### REFERENCE SINGS LIST

1: wet friction member
3: wet friction plate
5: core
7: heat spot

1. A wet friction member comprising:
base paper formed from a fiber base material and a filler; and
a binder for curing the base paper,
wherein the base paper contains a carbon-based material and does not contain diatomaceous earth.

2. A wet friction member according to claim 1, wherein the carbon-based material comprises carbon fibers and graphite.

3. A wet friction member according to claim 2, wherein the weight percentage of the carbon-based material in the wet friction member is larger than 20%.

4. A wet friction plate comprising a wet friction member according to claim 1.

5. A wet friction plate comprising a wet friction member according to claim 2.

6. A wet friction plate comprising a wet friction member according to claim 3.
